(19) United States
(12) Patent Application Publication
(10) Pub. No.: US 2007/0083726 A1
(43) Pub. Date: Apr. 12, 2007

(54) Storage allocation per application

(75) Inventors: Philip Steven Newton, Eindhoven (NL); Declan Patrick Kelly, Shanghai (CN); Folkert Gaayo Miedema, Eindhoven (NL); Koen Johanna Guillaume Holtman, Eindhoven (NL); Wiebe De Haan, Eindhoven (NL); Willem Bulthuis, Eindhoven (NL); Willem Peter Van Der Brug, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/575,412

(22) PCT Filed: Oct. 6, 2004
(86) PCT No.: PCT/IB04/03292

§ 371 Date: Apr. 10, 2006

(30) Foreign Application Priority Data
Oct. 13, 2003 (EP) 03300153.8

(51) Int. Cl. G06F 12/00

(52) U.S. Cl. 711/170; 711/115

(57) ABSTRACT

A device is equipped with local storage arrangement such as HDD and a removable optical storage carrier input device. Removable carriers include storage applications that necessitate storage space for storing data items. A storage management unit allocates storage space of the local storage arrangement to the inserted removable optical storage carrier and the application stored therein. The management unit also attributes to the portion identification information respecting access rights granted to the application with respect to data items stored in the allocated portion. The application is given no access to data items stored outside the allocated portion.

The invention relates to the field of storage and the combination of removable storage and local storage. The invention is more particularly directed to optical storage scanning devices equipped with local storage that can accommodate additional removable optical storage carriers where applications are configured to process data stored on the local storage.

BD-ROM (Blue Disc ROM) is the upcoming optical storage specification worked on by a consortium of consumer electronics, software companies and the entertainment industry for whom it is desirable to integrate the latest storage, playback and software technologies to develop the next carriers and players generation that combines both the opportunity of new user experiences and a high storage density. BD-ROM is the next Read-only optical disc standard, which utilizes a blue laser such that it is possible to obtain a capacity of at least 25 GB per data layer. Optical standards define both the physical and logical formats of carriers and players. The invention as described herein is directed to the logical aspect. A primary predicted application for BD-ROM is High Definition Television however web connectivity and interactivity such as web browsing, chat applications or games are also within the scope of the standard.

The current draft of the BD-ROM standard specifies a movie mode where digital Audio/Video (A/V) data is experienced through interaction with movie objects. The concept of movie mode encompasses functionalities similar to Digital Versatile Disc, which mostly relate to the playing of A/V content. A movie object can initiate a playlist comprising a list of A/V sequences stored on the disc and also permits the content author to do some pre- and post-processing with regards to A/V playback. The movie mode also includes titles as the items that the user sees and can select to playback. An index table links the titles to the movie objects.

In addition to this A/V playback capability, interactive services will be available in the new optical media generation and a programming environment is needed to enable interactive applications to be present on the disc. Java™, a SUN technology, with its existing Virtual Machine, Application Programming Interfaces and libraries was seen by the industry consortium as a good candidate technology to permit the feasibility of interactive applications on optical storage carriers. However several issues arise in the adaptation of a Personal Computer environment to consumer electronics devices as both the user experience and the industry's technical specification requirements are different from one environment to the other.

For example, in the world of consumer electronics (CE), which consists primarily of home devices, a main characteristic of developed applications and user interfaces is to be user-friendly and straightforward to permit quick market acceptance of the product. As a result, most content processing operations are transparent to the user and a user may not be aware of how applications access storage areas and what data is being accessed. Applications may thus access unauthorized data, corrupt data or perform illegal operations without the user knowing it.

In addition, consumer electronic devices process multimedia content protected by copyright and the entertainment industry is continuously expressing the desire to see the advent and deployment of technologies that would further prevent data corruption, illegal data copying or processing and that would prevent unauthorized applications or users from accessing the data.

The use of hard disc drives (HDD) or solid-state memories such as flash memories in CE products has changed the way multimedia content is experienced. It has also permitted to enable a greater variety of applications now offered to the users as interactivity and pre- and post-processing of multimedia content are now possible. In addition, the combination of permanent storage with removable storage in a given device has lead to a new sharing of the storage availability among the plurality of applications. Software applications stored on removable storage carriers may generate data when running. The generated data is for example associated with the user or the household, e.g. a profile, past-viewing history, preferences, gaming scores, or the like. Such data is often kept for the next session and instead of storing it on the carrier itself, the data may be stored on the local memory arrangement until the next session.

The inventors have thus sought a solution to enable the sharing of a local storage arrangement among applications stored on removable carriers.

A device is therefore proposed that includes a local storage arrangement for storing a plurality of items. The device further comprises a receptacle for inserting a removable storage carrier. The carrier contains one or more software applications. An allocation unit manages the local storage arrangement and allocates a portion thereof to the removable storage carrier. The portion is referenced with identification information respecting respective access rights to an item stored in the portion granted to the software application.

The invention is concerned with any type of data stored on the device's local storage, e.g. gaming scores, customized game characters, movies, songs, text files, user profiles, web content, commercials and the like. The invention seeks to prevent corruption of the stored data and illegal operations such as access or deletion by an unauthorized application. For example, the invention seeks to prevent a first interactive application to erase the household kids' cartoons from the home device's HDD when only last night television show should have been erased. The invention also seeks, for example, to prevent an application from retrieving user's private data specific to other applications for targeted commercials purposes. To this end, an allocation unit allocates a portion of the local storage arrangement to an inserted carrier. Alternatively, the allocation unit allocates the portion to one of the applications stored on the inserted carrier. In an exemplary embodiment a consequence of the allocation is that the application will not be authorized to see or access the remaining storage space of the local storage arrangement. Since the application may not see items stored outside the allocated portion, the application may not access or corrupt them inadvertently or on purpose. In a similar fashion, the user performing an incorrect manipulation when interacting an application does not run the risk of deleting data stored on the local storage specific to another application.

The allocation may be performed as follows. The allocation unit associated the portion with identification information respecting the access rights that the application is given with respect to items stored in the portion. The identification information may be associated with the disc and is, for example, a disc serial number or a disc publisher identifier. The identification information may also be representative of the software application instead of the carrier, e.g. an application reference number. Consequently, a storage portion or an item not associated with identification information specific to a given application will not be identified as an item that the application is authorized to access. The item will therefore not be presented to the application. Alternatively, in an implementation where the application is authorized to see the item but not to process it, access to it will be denied.

An advantage of one or more embodiments of the invention is to enable a plurality of independent applications to securely share a permanent storage locally available in the device. The invention also permits to free disc storage space from data specific to the user such as content or customized data.

The present invention will now be described in more detail, by way of examples, with reference to the accompanying drawings, wherein:

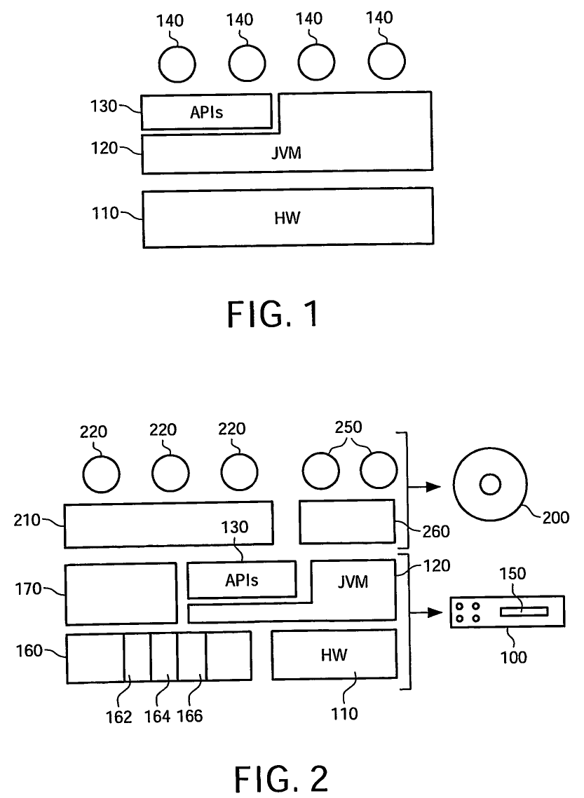

FIG. 1 shows the basic components of a Java environment; and,

FIG. 2 is an exemplary block diagram of a disc/player system of the invention.

Elements within the drawings having similar or corresponding features are identified by like reference numerals.

FIG. 1 illustrates the basic elements of a typical Java environment. A typical Java environment comprises software components that run on a device's hardware 110. The device may be a personal computer or a consumer electronics device such as a web tablet, a personal digital assistant, a game console, a set-top box and the like. The Java technology was originally designed to enable the same applications to execute on heterogeneous networks and on a variety of hardware architectures. The Java virtual machine (VM) 120 is the first component of the Java platform that enables this architecture-neutral technology. Java VM 120 is one of the two main components of the portable Java technology platform, for which Java programming language compilers can generate code. Java VM 120 can be modified or ported for adaptation to specific hardware 110. The Java platform, which is software only, further includes, in addition to Java VM 120, Java Application Programming Interface (API) 130. Java API 130 is a large collection of ready-made software components that provide many useful capabilities, such as graphical user interface (GUI), connectivity, I/O, storage, etc. Java API 130 is grouped into libraries of related classes and interfaces; these libraries may also be known in the industry as packages. Then, on top of the Java platform 120, 130, set of developers' applications 140 written in Java code may be executed.

FIG. 2 shows a block diagram of a BD-ROM system of the invention. The system includes disc 200 and player 100. Player 100 includes hardware 110, storage arrangement 160, Application Programming Interface 130 with Java libraries, Java VM 120 and storage space allocation unit 170. BD-Rom disc or blue ray disc 200 includes a loader application 210, Java objects 220, A/V data 260 and movie objects 250. More details on the loader application 210 and Java objects 220 can be found in European Patent application EP03292522.4 (Attorney docket number FR030119), entitled “Java lifecycle model for BD discs” filed Oct. 10, 2003, herewith incorporated by reference.

It must be noted that although the invention will be described in the context of the BD-Rom, the invention encompasses any current or future type of storage carriers and players, optical or not, that satisfy the specifics of the invention, whether the carrier is read-only, writable or re-writable.

Player 100 of the invention includes permanent storage arrangement 160 that may be implemented, e.g., in the form of a hard disc drive (HDD) or a solid-state memory, e.g. flash memory. Storage arrangement 160 serves as a local memory for player 100 and may be removed and replaced if needed. For example, arrangement 160 is a USB flash memory specific to a user and includes data personal to the user. In an exemplary embodiment, arrangement 160 needs to be present in player 100 for player 100 to read disc 200. Player 100 includes receptacle 150 where disc 200 is inserted into player 100. The invention relates to the allocation of memory space of arrangement 160 among discs 200. To this end, player 100 includes allocation unit 170 in charge of the allocation of portions 162-166 of storage space of arrangement 160.

Unit 170 allocates storage portions 162, 164, 166 to discs 200 inserted into player 100 as follows. In a first embodiment, unit 170 may equally allocate memory space of arrangement 160 among discs 200. In an alternative embodiment, unit 170 allocates portions 162-166 based on the respective space requirements of the applications 220, 250 stored on discs 200. It is also to be noted that unit 170 may adapt the storage allocation with time and may extend the size of portion 162-166 if an application 220, 250 requires additional memory space as will be explained hereinafter.

Storage arrangement 160 stores a plurality of data items. Data items include among others content data, user profile data, viewing history, transaction history, web content, text files, gaming scores, game avatars and the like. The invention seeks to prevent a given application 220, 250 from accessing, and in some instances from knowing of, data specific to another application 220, 250. Thus, unit 170 associates data items specific to a given application 220, 250 with an identification information respecting access rights the application 220, 250 is granted with respect to these data items. Access rights will be discussed in more details hereinafter. The identification information may include an identifier representative of carrier 200. Identification information may also include an identifier representative of the application 220, 250 itself. Identifier is, for example, a BCA (Burst Cutting Area), a serial number that allows individual instances of disc 200 to be identified, a disc identifier that indicates current disc 200 or a publisher identifier. Identifier may also be a generated title identifier derived from content stored on the disc 200 however this latter type of identifier may not be unique to disc 200. The identifier may also be a combination of the above.

A BD ROM disc 200 contains a number of titles and Java objects 220 and movie objects 250 as defined above. As mentioned previously, the invention encompasses associating the items stored in arrangement 160 with disc 200 or, alternatively, associating the items with the individual applications 220, 250. Unit 170 may allocate a portion 162-166 of arrangement 160 to a given application 220, 250 at the time the application 220, 250 is running on player 100 and/or requesting memory space. Indeed, unit 170 may allocate memory space 162-166 only when needed. For example, unit 170 allocates portion 162-166 to application 220, 250 when application 220, 250 causes the download of a song or a movie from the Web. In another embodiment, unit 170 allocates storage portion 162-166 to current application 220, 250 when instructions in the application 220, 250 cause commercials to be downloaded from an Internet server for later insertion into multimedia content. Alternatively, unit 170 may allocate storage space 162-166 based on a publisher identifier present on the disc 200. As a result any application or disc with the publisher identifier may only store data items in the space 162-166 allocated to that publisher. As mentioned earlier, allocated space may be extended if additional space is required.

The invention seeks to segment arrangement 160 among discs 200 and as a result each disc 200 inserted in player 100 may see a different file system. Indeed, all other data items not associated with disc 200 will be hidden. In this embodiment, there is no sharing of content between discs 200. Another consequence of this implementation is that a new disc 200 may see arrangement 160 as an empty file system with no directory structure. Disc 200 or its stored applications 220, 250 can create directories in this empty structure and store data items therein. If disc 200 lists data items stored in arrangement 160, it will only see data items and directories it created. In addition, unit 170 permits disc 200 to delete these files only.

Although shown as a separate block entity in FIG. 2, unit 170 may be implemented in software and comprised in Application Programming Interfaces (API) 130. Indeed, unit 170 may be derived from standard publicly available storage management Java APIs. Unit 170 may be further standardized for BD-ROM players 100 to enable uniform implementations across the players' industry. Unit 170 grants and restricts the access rights it gives to disc 200 or applications 220, 250 with respect to portion 162-166 or data items stored therein. To this end, unit 170 may include a first API that controls a “Dir” command that lists all available and authorized data items, a second API that controls a “Create” command for creating new data items, a third API that controls a “Delete” command for deleting selected files, a fourth AP that controls a “Write” command for modifying an existing data item and a fifth API that controls a “make/delete directory” command that enables modifying the directory structure. These exemplary APIs are configured to enable disc 200 or application 220, 250 to process data stored in allocated storage portions 162-166. The access rights that unit 170 grants to a specific application 220, 250 or disc 200 with respect to a given data item may be attached to the item. The access rights are included in identification information mentioned above. Identification information is stored with the data item or within the allocated portion. The identification information includes the disc or application identifier.

When disc 200 is inserted in receptacle 150, unit 170 first retrieves disc identifier or application identifier from disc 200. If disc 200 or an application 220, 250 on disc 200 requests access to arrangement 160, e.g. to access, delete, modify stored data or to store new data, unit 170 first identifies which items or portions the application 220, 250 or the disc 200 is authorized to access. If the disc 200 is inserted in player 100 for the first time, unit 170 may allocate new portion 162-166 to disc 200 as explained previously. If a portion 162-166 was allocated in a previous session to disc 200 or application 220, unit 170 retrieves data items stored in portion 162-166 based on identifier. Unit 170 then determines the access rights granted to disc 200 or application 220 with respect to the data items from the identification information stored with the data items. Access rights may be granted uniformly for portion 162-166 which means that application 220 or disc 200 is granted the same access rights with respect to all data items stored in portion 162-166. Alternatively, unit 170 may grant an application 220 specific access rights with respect to individual data items contained in portion 162-166. Allocation unit 170 may generate an allocation table linking applications 220, 250 or discs 200 and the allocated portions 162-166. The allocation table may be stored in arrangement 160.

In another embodiment, unit 170 may need to free storage space in arrangement 160 when the whole storage space of arrangement 160 has been allocated. Unit 170 may reduce portions allocated to other applications by deleting data items or by using space initially allocated and unused by the other applications. Data items that have not been used recently by the associated application may be deleted first. If no additional storage space can be found in arrangement 160, the user may be informed or the application that is requesting additional memory space aborted.

It is to be understood that the term “portion” may also refer to data items. Indeed, a data item stored in arrangement 160 may be understood as memory space of arrangement 130 and both terms may be used indifferently.

In another embodiment, a link may be written on disc 200 linking to the allocated portion 162-166. Allocation unit 170 may control the insertion of the link onto disc 200 and control the access rights granted to disc 200 or application 220, 250 in this manner.

It will be evident to one skilled in the art that numerous other alternatives fall within the scopes of the appended claims. In this respect, the following closing remarks are made. There are numerous ways of implementing functions by means of items of hardware or software, or both. For example, the drawings presented here are diagrammatic, each only representing one embodiment. Thus, although a drawing shows different functions as different blocks, this by no means excludes that a single item of hardware or software carries out several functions. Nor does it exclude that a function is carried out by an assembly of items of hardware or software, or both.

1. A device (100) comprising:
a local storage arrangement (160) for storing a plurality of data items;
a receptacle (150) for receiving a removable storage carrier (200) storing a software application (220);
a storage management unit (170) for allocating a portion (162-166) of the local storage arrangement to the removable storage carrier and referencing the portion with an identification information respecting respective access rights to a data item stored in the portion granted to the software application.

2. The device of claim 1, wherein the storage management unit comprises Application Programming Interfaces that control an access to the local storage arrangement.

3. The device of claim 1, wherein the access rights include at least one of the following with respect to the data item: viewing, reading, executing, accessing, retrieving, deleting, writing and saving.

4. The device of claim 1, wherein the identification information includes an identifier of the removable storage carrier.

5. The device of claim 4, wherein the identification information includes a unique identification number associated with the removable storage carrier.

6. The device of claim 4, wherein the identification information is one of the following: Burst Cutting Area.

7. The device of claim 1, wherein the identification information includes an identifier of the software application.

8. The device of claim 1, wherein the identification information is representative of a publisher of the removable storage carrier.

9. The device of claim 1, wherein the storage management unit further enables the software application to store additional data item in the allocated portion.

10. The device of claim 1, wherein the storage management unit limits a size of the portion allocated to the removable storage carrier.

11. The device of claim 1, wherein the storage management unit causes one or more data items not comprised in the allocated portion to be hidden from the software application.

12. The device of claim 1, wherein the portion comprises the item only.

13. The device of claim 1, wherein the storage management unit grants no access rights to the software application with respect to other data items stored outside the allocated portion.

14. The device of claim 1, wherein the storage management unit hides to the software application other data items stored outside the allocated portion.

15. A method for managing a local storage arrangement in a device comprising:
allocating a portion of the local storage arrangement to an optical storage carrier inserted in the device;
granting access rights to a software application stored on the carrier with respect to a data item stored in the portion; and,
including in the portion identification information respecting the access rights.
